(19) United States
(12) Patent Application Publication
(10) Pub. No.: US 2017/0046330 A1
(43) Pub. Date: Feb. 16, 2017

(54) CONTEXT SPECIFIC LANGUAGE MODEL FOR INPUT METHOD EDITOR

(71) Applicant: Google Inc., Mountain View, CA (US)

(72) Inventors: Xiance Si, Beijing (CN); Edward Y. Chang, Mountain View, CA (US)

(73) Assignee: Google Inc., Mountain View, CA (US)

(21) Appl. No.: 15/307,185

(22) PCT Filed: Apr. 28, 2014
(86) PCT No.: PCT/CN2014/076360

§ 371 Date: Oct. 27, 2016

(51) Int. Cl. G06F 17/27; G06F 3/0482

(52) U.S. Cl. CPC G06F 17/276; G06F 17/277; G06F 17/275; G06F 3/0482

(57) ABSTRACT

A computer-implemented method can include receiving, at a computing device having one or more processors, a plurality of textual inputs. Each of the textual inputs can be received in association with an input field. The method can also include receiving, at the computing device, a plurality of unique identifiers. Each unique identifier can be associated one of the plurality of textual inputs and identify a type of the input field. The method can also include building, at the computing device, a language model associated with each particular unique identifier. Each language model can be based on the textual inputs associated with the particular unique identifier. Further, the method can include storing, at the computing device, the language models such that each particular language model can be retrieved based on its associated particular unique identifier.

### FIELD

The present disclosure relates to an input method editor and, more particularly, to techniques for creating and utilizing a context specific language model to assist a user that is inputting text to a computing device.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A user may provide a text input to a computing device by interacting with one or more peripherals, such as a keyboard, keypad or touch display. In some instances, a user may utilize an Input Method Editor (“IME”) to assist the user when entering text. An IME may assist a user in entering text in a first script to obtain a representation of the text in a second script. For example only, a user may wish to input Chinese text in Hanzi characters through the use of a Latin or Roman keyboard, e.g., by entering a Pinyin representation of the text. Alternatively or in addition, a computing device may facilitate text input from a user by suggesting candidate words or characters in the same script as the text input, which is sometimes referred to as “autocorrect” and/or “autocomplete” functionality. In each of these examples, the computing device attempts to determine/predict what text the user is intending to input.

An IME may utilize a language model to assist with prediction. A typical language model can provide a probability of possible n-gram candidates (e.g., letters, words, or phrases) occurring based on an input. For example only, a language model for the English language can provide the probability for the candidates “hello,” “help,” etc. based on an input of “hel” by a user. The probabilities for n-gram candidates can be determined from a data set of source text, which may comprise many millions of n-grams arranged in sequence. Assuming that the source text is statistically representative of the language and its use generally, the language model can be considered a general language model that is representative, generally, of the language.

In some cases, however, a user may wish to input text in a context for which a general language model may not be particularly helpful. It would be desirable to provide a context specific language model that increases the accuracy and speed of prediction for an IME.

### SUMMARY

In some embodiments of the present disclosure, a computer-implemented method for building context specific language is disclosed. The method can include receiving, at a computing device having one or more processors, a plurality of textual inputs. Each of the textual inputs can be received in association with an input field. The method can also include receiving, at the computing device, a plurality of unique identifiers. Each unique identifier can be associated one of the plurality of textual inputs and identify a type of the input field. Further, the method can include building, at the computing device, a language model associated with each particular unique identifier. Each language model can be based on the textual inputs associated with the particular unique identifier.

The method can additionally include receiving, at the computing device, a request for a context specific language model from a user computing device. The request can include a first unique identifier of the plurality of unique identifiers. The context specific language model can be identified based on the request and the first unique identifier. Also, the method can include transmitting, from the computing device, the context specific language model to the user computing device.

In various embodiments, a computer system is disclosed. The computer system can include one or more processors and a non-transitory, computer readable medium storing instructions that, when executed by the one or more processors, cause the computer system to perform operations. The operations can include receiving a plurality of textual inputs. Each of the textual inputs can be received in association with an input field. The operations can also include receiving a plurality of unique identifiers. Each unique identifier can be associated one of the plurality of textual inputs and identify a type of the input field. Further, the operations can include building a language model associated with each particular unique identifier. Each language model can be based on the textual inputs associated with the particular unique identifier.

The operations can additionally include receiving a request for a context specific language model from a user computing device. The request can include a first unique identifier of the plurality of unique identifiers. The context specific language model can be identified based on the request and the first unique identifier. Also, the operations can include transmitting the context specific language model to the user computing device.

In further embodiments, a computer-implemented method is disclosed. The method can include receiving, at a computing device having one or more processors, a plurality of textual inputs. Each of the textual inputs can be received in association with an input field. The method can also include receiving, at the computing device, a plurality of unique identifiers. Each unique identifier can be associated one of the plurality of textual inputs and identify a type of the input field. The method can also include building, at the computing device, a language model associated with each particular unique identifier. Each language model can be based on the textual inputs associated with the particular unique identifier. Further, the method can include storing, at the computing device, the language models such that each particular language model can be retrieved based on its associated particular unique identifier.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 illustrates a user interacting with an example computing device according to some implementations of the present disclosure;

FIG. 2 is a functional block diagram of the computing device of FIG. 1 according to some implementations of the present disclosure;

FIG. 3 is a functional block diagram of a user interacting with another example computing device according to some implementations of the present disclosure; and

FIG. 4 is a functional block diagram of a user interacting with another example computing device according to some implementations of the present disclosure;

FIG. 5 is a flow diagram of an example technique for building context specific language models and assisting a user in providing textual input to a computing device according to some implementations of the present disclosure; and

FIG. 6 is a flow diagram of an example technique assisting a user in providing textual input to a computing device according to some implementations of the present disclosure.

### DETAILED DESCRIPTION

A user may input text to a computing device, e.g., in order to draft an email or other electronic message, to interact with a web page (enter a search query, provide a “user comment”), or to compose a newspaper article, book or research paper. In some situations, the computing device can provide assistance to a user that is providing input text.

As mentioned above, an Input Method Editor (“IME”) can provide assistance to a user that wishes to input text in a script that is different from the script provided to the user for selection. For example, a user may utilize a Latin keyboard to input Chinese text in Hanzi characters utilizing a Pinyin IME. Additionally or alternatively, the computing device can include autocorrect and/or autocomplete functionality that provides candidates (words/syllables/phrases/etc.) to the user based on an incorrect and/or partial input.

In some situations, a user may wish to input text in a context that is different from a general context and, accordingly, for which a general language model may be inappropriate or ineffectual. For example only, if a user is attempting to input text in a “name” input field of a “contacts” section of an email or other messaging application, a general language model may not be especially useful as the general language model would not prioritize typical names, which is what the user would be expected to enter, over words that are more generally common. Similarly, for inputting text in an input field of an application that utilizes special or invented words, such as a game that utilizes its own lexicon, a general language model may be wholly inappropriate for quickly entering text as the special words would likely not be present in the general language model.

The present disclosure relates to a technique for utilizing the context of the input to assist a user inputting text. The context of the input can be utilized to identify a context specific language model to increase the accuracy and speed of the assistance tools of the computing device in order to determine the text that is intended by the user based on the input.

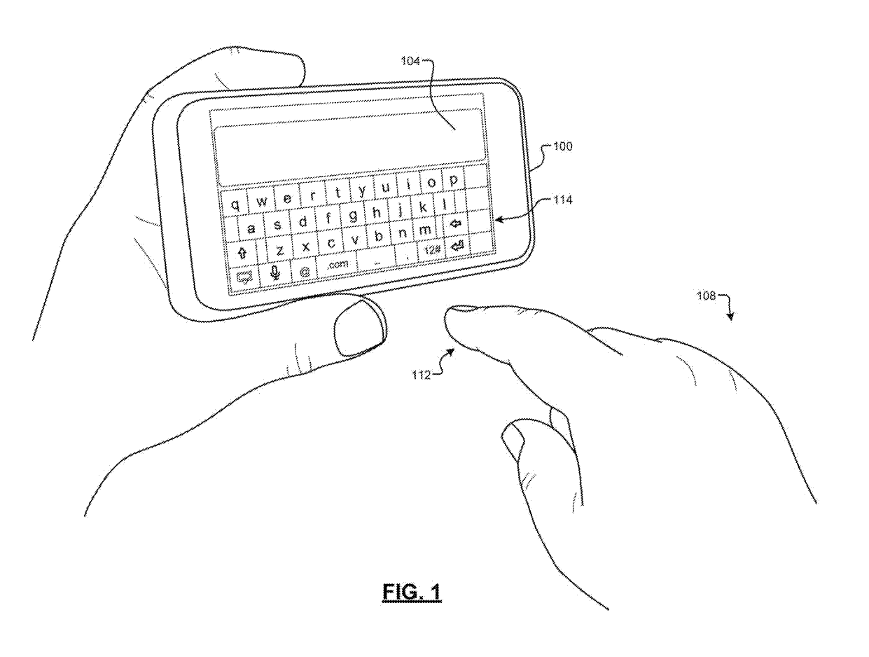

Referring now to FIG. 1, an example computing device 100 is shown. The computing device 100 is illustrated as a mobile device (such as a mobile phone, a tablet computer or “phablet” computer), although it should be appreciated that the term “computing device” can include any form of computer(s) or computer system(s) that include one or more processors for executing instructions. For example only, a computing device can take the form of a desktop computer, a laptop computer, a mobile device (such as a mobile phones, tablets, phablets, and wearable computers), and a server or other distributed computer system, as well as two or more of these example computing devices working together to perform an operation.

The illustrated computing device 100 includes a display 104, such as a touch display as shown. The computing device 100 may additionally or alternatively include a physical keyboard (not shown). The touch display 104 may display information to, and receive input from, a user 108. A “soft” keyboard 114 may be provided on the display 104 through which the user 108 can provide text input. The illustrated keyboard is a Latin keyboard providing Latin alphabet characters, as well as other input options (numbers, a space bar, symbols, etc.). The user 108 may input text to the computing device 100 via the touch display 104 and/or keyboard 114 using one or more fingers 112.

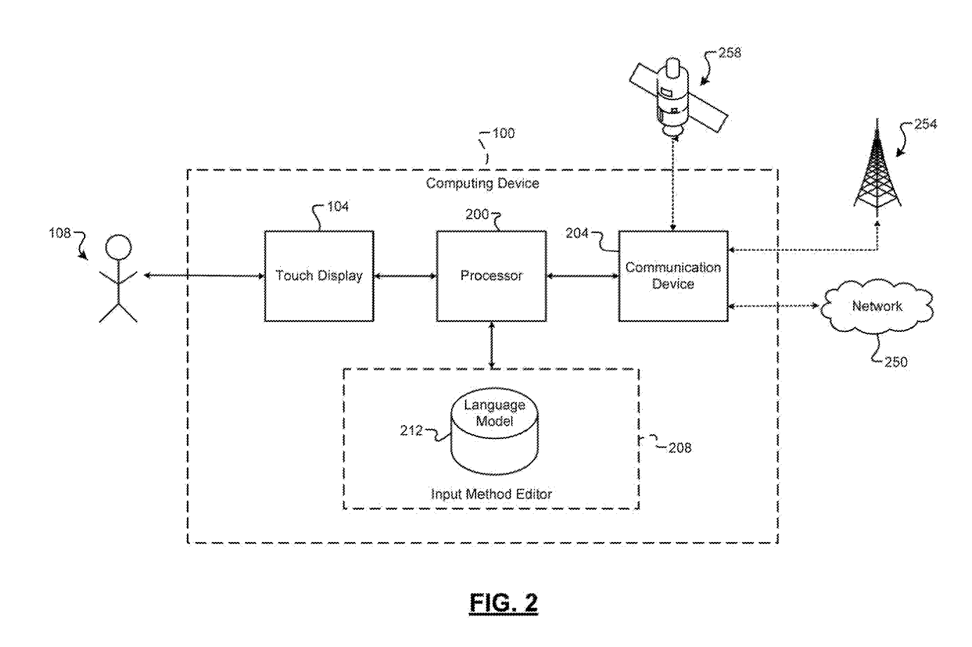

Referring now to FIG. 2, a functional block diagram of the example computing device 100 is shown. The computing device 100 can include a processor 200 and a communication device 204. The term “processor” as used herein refers to both a single processor, as well as two or more processors operating together, e.g., in a parallel or distributed architecture, to perform operations of the computing device 100. The computing device 100 can further include an IME 208 that includes and utilizes a language model 212. While shown and described herein as separate components of the computing device 100, the IME 208 and the language model 212 can be implemented by the processor 200. It should be appreciated that the computing device 100 can include additional computing components that are not illustrated in FIG. 2, such as memory, a microphone, a speaker, one or more buttons and the like.

The processor 200 controls most operations of the computing device 100. For example, the processor 200 may perform tasks such as, but not limited to, loading/controlling the operating system of the computing device 100, loading/configuring communication parameters for the communication device 204, controlling IME parameters, and controlling memory storage/retrieval operations, e.g., for loading of the various parameters. Further, the processor 200 can control communication with the user 108 via the touch display 104 of the computing device 100.

The processor 200 may provide the user 108 with various different character input configurations via the touch display 104. For example, the processor 200 may provide the user 108 with a form of the standard Latin “QWERTY” keyboard as shown. Alternatively, the processor 200 may provide the user 108 with a standard 12-key configuration, also known as a T9-input based character configuration, or other keyboard configuration.

The processor 200 may receive input from the user 108, e.g., via the provided character input configuration. The processor 200, however, may also provide various IMEs, e.g., IME 208, to assist the user 108 with inputting text to the computing device 100. The processor 200, therefore, may also convert the input received from the user 108 to one or more desired scripts, e.g., Chinese Hanzi, by converting the user text input in a different script, e.g., in Pinyin. For example, the processor 200 may use the IME 208, in conjunction with the language model 212, when interpreting the user text input (described in detail below).

The communication device 204 controls communication between the computing device 100 and other devices/networks. For example only, the communication device 204 may provide for communication between the computing device 100 and other computing devices associated and/or the Internet. The computing device 100 may typically communicate via one or more of three communication mediums: a computing network 250, e.g., the Internet (hereinafter “the network 250”), a mobile telephone network 254, and a satellite network 258. Other communication mediums may also be implemented. For example, the communication device 204 may be configured for both wired and wireless network connections, e.g., radio frequency (RF) communication.

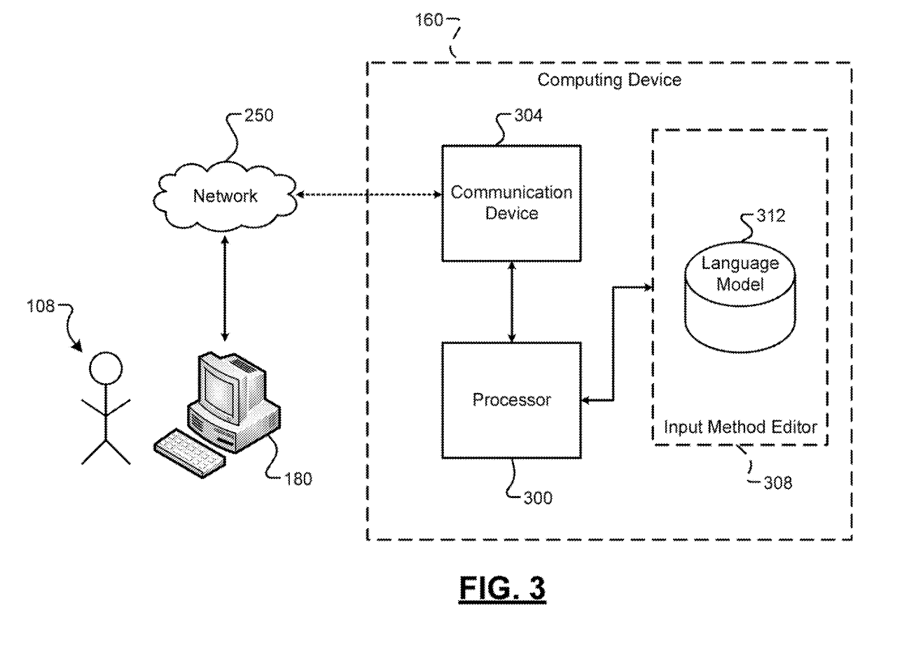

Referring now to FIG. 3, another example computing device 160 for providing context sensitive input tools to a user 108 is illustrated. The computing device 160 is in communication with a computing device 180 of the user 108 via the network 250 (such as the Internet). The computing device 180 is illustrated as a desktop computer, but it should be appreciated that the computing device 180 could be any computer or computer system, such as the computing device 100 illustrated in FIGS. 1-2. Additionally, the computing device 160 will be described in the context of operating as a server, but the computing device 160 can also be any other type of computer or computer system.

Similar to the computing device 100 described above, the computing device 160 can include a processor 300 and a communication device 304, which can operate in a manner similar to the processor 200 and the communication device 204, respectively, described above. The computing device 160 can further include an IME 308 and a language model 312, which can operate in a manner similar to the IME 208 and the language model 212, respectively, described above. Further, it should be appreciated that, while shown and described herein as separate components of the computing device 160, one or both of the IME 308 and the language model 312 can be implemented by the processor 300. The computing device 160 can communicate with the computing device 180 of the user 108 via the network 250.

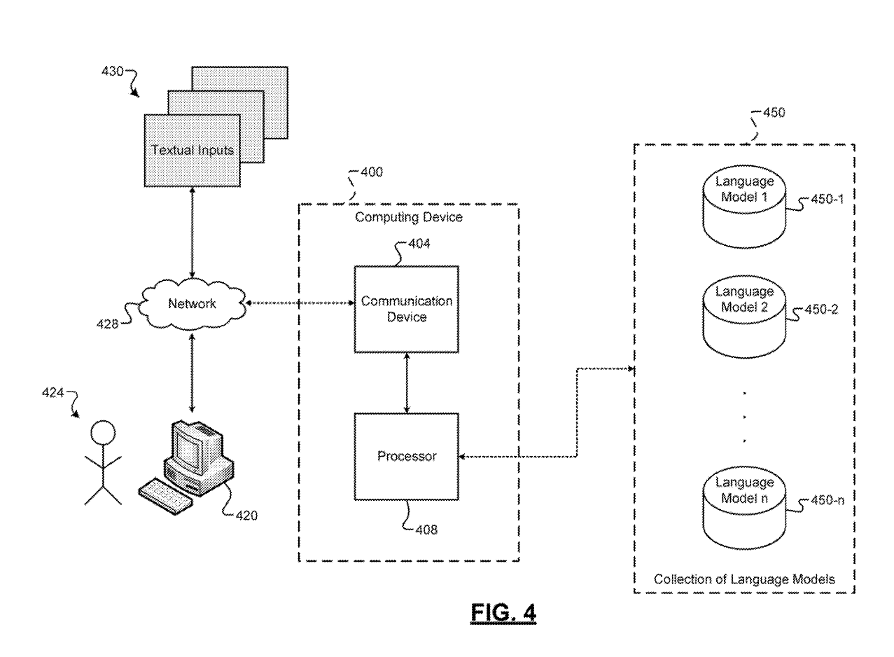

Referring now to FIG. 4, another example computing device 400 for building and providing context sensitive input tools to a user 108 is illustrated. The computing device 400 is in communication with a computing device 420 of a user 424 via a network 428 (such as the Internet). The computing device 420 is illustrated as a desktop computer, but it should be appreciated that the computing device 420 could be any computer or computer system, such as the computing device 100 illustrated in FIGS. 1-2, or one of the computing devices 160, 180 illustrated in FIG. 3. The computing device 400 will be described in the context of operating as a server, but the computing device 400 can also be any other type of computer or computer system.

The computing device 400 can receive a plurality of textual inputs 430. It should be appreciated that the textual inputs 430 can be received by the computing device 400 in a serial manner (one at a time over a specific period), in groups of a plurality of textual inputs 430 (a collection of textual inputs 430 at one time), or both. The textual inputs 430 can be received via the network 428 as shown, or via any other method of communication (e.g., by retrieving the textual inputs 430 from a memory). In some examples, a textual input 430 can be created by the user 424 inputting text to an application executing at the computing device 420, which transmits the textual input 430 to the computing device 400. The plurality of textual inputs 430 can be received from a single user 424 or a plurality of users. The plurality of textual inputs 430 can be stored at a local memory (not shown) of the computing device 400, or remotely.

Each of the textual inputs 430 can be received in association with an input field. For example only, an application may provide various mechanisms or locations in which a user can input text. These “input fields” can be associated with a unique identifier by the application, which can identify a type (name field, city field, sports term field, etc.) of the input field. A textual input 430 received in a particular input field can be associated with the unique identifier of that particular input field. Thus, a textual input of “Joanna Doe” in a name input field can be associated with a unique identifier that identifies the textual input 430 as a type of name.

Accordingly, the computing device 400 can also receive a plurality of unique identifiers associated with the textual inputs 430. Based on the received textual inputs 430 and their associated unique identifiers, the computing device 400 can build a collection of context specific language models 450-1, 450-2 . . . 450-n (collectively, “language models 450”), as more fully described below. In embodiments for which the textual inputs 430 are received from a single user 424, the context specific language models 450 can also be user specific.

As mentioned above, a language model can provide a probability of possible n-gram candidates (e.g., letters, words, or phrases) occurring based on an input. The probabilities for each of the n-gram candidates can be determined from a data set of source text, which may comprise many millions of n-grams arranged in sequence. There are many ways of building a language model from a data set. For example only, each unique n-gram in the data set can be identified. A probability for each unique n-gram in the data set can also be calculated, e.g., by counting the number of occurrences for each particular n-gram and dividing by the total number of n-grams in the data set. The language model can then be built by associating each unique n-gram with its probability of occurrence. It should be appreciated that there are many techniques for building a language model and the present disclosure can be utilized with any of these techniques.

The present disclosure contemplates building a plurality of context specific language models 450 based on different data sets of a plurality of textual inputs 430. Each context specific language model 450 can be based on the textual inputs 430 associated with a particular unique identifier. The textual inputs 430 associated with a particular unique identifier are identified and assembled into a data set upon which the associated context specific language model 450 is based. A probability of occurrence associated with each token of the textual inputs 430 can be determined and stored with its corresponding token to create the context specific language model 450. The context specific language model 450 can be indexed or otherwise associated with its particular unique identifier such that the appropriate context specific language model 450 can be retrieved based on its associated unique identifier.

In some embodiments, building the context specific language models 450 can be performed by adapting a previously existing language model. For example only, a general language model (one that is built on a “general” data set) can be adapted based on the textual inputs 430 associated with a particular unique identifier to create a context specific language model 450 for that particular unique identifier. Adapting the general language model can include, e.g., increasing the probabilities of occurrence of particular tokens in the general language model when those particular tokens are also present in the plurality of textual inputs 430 associated with the unique identifier. Other forms of language model adaptation can additionally or alternatively be performed.

After building the context specific language models 450, the computing device 400 can provide the context specific language models 450 to user computing devices for utilization. In various embodiments, the computing device 400 can receive a request for a context specific language model 450, e.g., from a user computing device such as computing device 100, 180 or 420. The request can include a particular unique identifier that identifies the type of the input field for which the context specific language model 450 can be used. The computing device 400 can identify the appropriate context specific language model 450 based on the request and the particular unique identifier, and transmit the appropriate context specific language model 450 to the user computing device.

In some embodiments, the request for the context specific language model 450 can further include an application identifier that identifies an application associated with the context specific language model 450. For example only, a user 108, 424 may request a particular application be downloaded or otherwise installed on the user computing device 100, 180, 420. The computing device 400 can transmit the application (or otherwise cause the application to be transmitted) to the user computing device, together with or separately from the context specific language model 450. In this manner, an application can be configured with its associated context specific language model(s) 450 upon installation of the application.

When one or more of the context specific language models 450 are transmitted to the user computing devices (such as computing device 100), the context specific language model(s) 450 can be stored and utilized by an IME (such as IME 208). Alternatively or additionally, the context specific language models 450 can be stored remotely from a user computing device and access to the context specific language models 450 can be provided to the user computing device by the computing device 400. In one example, the computing device 400 can receive text from the user computing device, identify at least one text candidate based on the identified context specific language model 450 and the received text, and transmit the at least one candidate to the user computing device. In another example, the computing device can provide access to a context specific language model 450 by transmitting the context specific language model 450 to a separate computing device (such as computing device 160) with which the user computing device (such as computing device 180) interacts. With reference to FIG. 3, the separate computing device 160 can utilize the context specific language model(s) 450, e.g., with the IME 308.

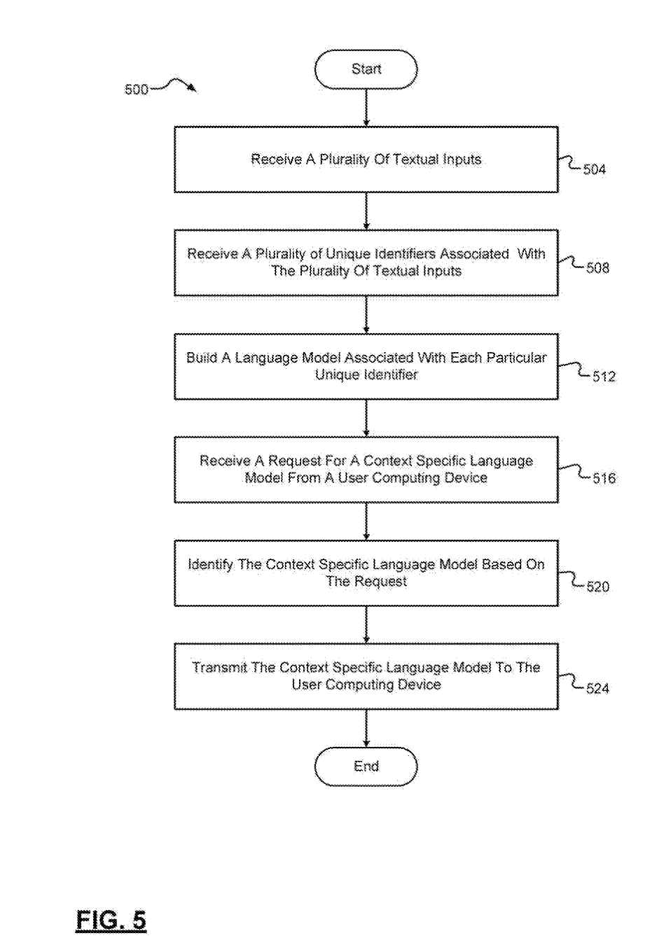

Referring now to FIG. 5, an example technique 500 for building and utilizing a context specific language model 450 is illustrated. While described as being performed by the computing device 400, it should be appreciated that the operations can be performed by one or more specific components of the computing device 400 (such as the processor 408 or the communication device 404), the computing device 100, 160, 180 or 420 and/or specific components thereof, or a combination of these elements. Further, the technique 500 can be implemented by a computer system that includes: (i) one or more processors, and (ii) a non-transitory, computer readable medium storing instructions that, when executed by the one or more processors, cause the computer system to perform the operations of the technique 500.

At 504, the computing device 400 can receive a plurality of textual inputs 430. As mentioned above, the textual inputs 430 can be received from a single user or a plurality of users. The computing device 400 can further receive a plurality of unique identifiers associated with the plurality of textual inputs 430 at 508. Each unique identifier may identify the type of input field associated with its corresponding textual input 430. Based on the textual inputs 430 and their associated unique identifiers, at 512 the computing device 400 can build a language model 450 associated with each particular unique identifier, as described above. Building the language models 450 can also include adapting a general language model based on the textual inputs 430. Once the plurality of language models 450 are built, the plurality of language models 450 can be stored such that each particular language model 450 can be retrieved for use based on its associated particular unique identifier.

At 516 the computing device 400 can receive a request for a context specific language model 450 from a user computing device 100, 180, 420. The request can include a first unique identifier of the plurality of unique identifiers. At 520 the computing device 400 can identify one of the language models 450 as the context specific language model based on the request and the first unique identifier. The computing device 400 can transmit the context specific language model 450 to the user computing device at 524.

The techniques for utilizing the context specific language models 450 described herein can be performed by any of the computing devices 100, 160, 180, 400, 420 working alone or in conjunction with one another. For the sake of simplicity, however, the description below will primarily refer to various operations of the computing device 100. It should be appreciated that the operations can be performed by one or more specific components of the computing device 100 (such as the processor 200 or the communication device 204), the computing device 160, 180, 400, or 420 and/or specific components thereof, or a combination of these elements.

The user 108 can provide textual input to the computing device 100 via any one or more input devices, such as the display 104, the soft keyboard 114, a physical keyboard (not shown), or a microphone (not shown). The textual input can be a keyboard entry, a handwritten stroke or strokes (for handwriting-to-text functionality), or a voice input (for speech-to-text functionality), although other forms of inputs could be utilized. The textual input can include one or more characters (or portions of a character).

The computing device can receive the textual input from the user 108 directly (from the user 108 interacting with the computing device 100) or indirectly (e.g., the computing device 160 can receive the input from the user 108 via another computing device 100, 180). The textual input can be received in association with an input field. An input field can be any field, location or area of an application to which the textual input is to be added. As described above, the input field can be associated with a unique identifier that, e.g., identifies a type of the input field.

In order to provide text input assistance, the computing device 100 can identify the unique identifier of the input field to which the textual input is to be added. A context specific language model 450 associated with the unique identifier can also be identified. The IME 208 can utilize the context specific language model 450 to generate one or more text candidates for the textual input and a probability for each of the text candidates.

Once the one or more text candidates have been determined, the computing device 100 can output a list of the one or more candidates (or a subset of the one or more candidates) for display to the user 108. For the computing device 100 that includes a display 104, the outputting of the list of candidates can include displaying the candidates. For the computing device 160, the outputting of the list of candidates can include providing the list of candidates to another computing device 100, 180 for display by the other computing device 100, 180. In some embodiments, the list of candidates can be output in the ranked order, e.g., determined based on the combined probability described above. Further, the user 108 can select a particular candidate as representative of the textual input intended by the user 108. The computing device 100 can receive the selection of the particular candidate for inclusion in the input field.

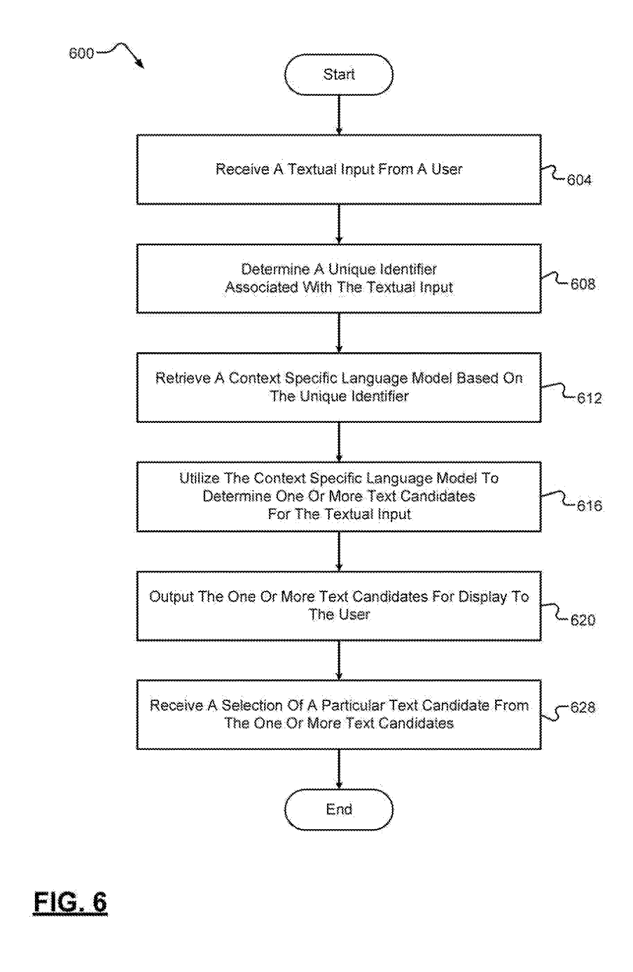

Referring now to FIG. 6, an example technique 600 for assisting a user 108 in providing text input to a computing device 100 is illustrated. While described as being performed by the computing device 100, it should be appreciated that the operations can be performed by one or more specific components of the computing device 100 (such as the processor 200 or the communication device 204), the computing device 160, 180 or 420 and/or specific components thereof, or a combination of these elements. Further, the technique 600 can be implemented by a computer system that includes: (i) one or more processors, and (ii) a non-transitory, computer readable medium storing instructions that, when executed by the one or more processors, cause the computer system to perform the operations of the technique 600.

At 604, the computing device 100 receives a textual input from the user 108. The textual input can include, e.g., one or more characters in a first script that is representative of text in a particular language. Further, the textual input can be received in association with an input field of an application that is executing at the computing device 100. At 608, the computing device 100 can determine a unique identifier associated with the textual input.

The computing device 100 can retrieve a context specific language model 450 based on the unique identifier at 612. Retrieval of the context specific language model 450 can include receiving the context specific language model from a memory or another computing device. At 616, the computing device 100 can utilize the context specific language model 450 to determine one or more text candidates for the textual input.

As described above, the context specific language model 450 can express a probability of occurrence of the one or more text candidates. In some embodiments, the candidates can include one or more characters in a second script representative of the text in the particular language. In the situation where the computing device 100 is providing autocorrect and/or autocomplete functionality, the first and second scripts can be identical. In the situation where the computing device 100 is providing a translation and/or transliteration functionality (alone or in combination with autocorrect and/or autocomplete), the first and second scripts can be different. For example only, the user 108 may provide the input in the Latin alphabet to input Chinese text in Hanzi characters utilizing a Pinyin IME.

At 620, the one or more text candidates can be output for display to the user, e.g., at the user computing device 100, 180, 420. A selection of a particular text candidate from the list of the one or more text candidates can be received at 628. The technique 600 may then end or return to 604 for one or more additional cycles.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the terms module or device may refer to, be part of, or include an Application Specific Integrated Circuit (ASIC); an electronic circuit; a combinational logic circuit; a field programmable gate array (FPGA); a processor (shared, dedicated, or group) that executes code, or a process executed by a distributed network of processors and storage in networked clusters or datacenters; other suitable components that provide the described functionality; or a combination of some or all of the above, such as in a system-on-chip. The terms module or device may include memory (shared, dedicated, or group) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), flash memory or any other type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present disclosure.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method, comprising:
receiving, at a computing device having one or more processors, a plurality of textual inputs, each of the textual inputs being received in association with an input field;
receiving, at the computing device, a plurality of unique identifiers, each unique identifier being associated one of the plurality of textual inputs and identifying a type of the input field;
building, at the computing device, a language model associated with each particular unique identifier, each language model being based on the textual inputs associated with the particular unique identifier;
receiving, at the computing device, a request for a context specific language model from a user computing device, the request including a first unique identifier of the plurality of unique identifiers;
identifying, at the computing device, the context specific language model based on the request and the first unique identifier; and
transmitting, from the computing device, the context specific language model to the user computing device.

2. The computer-implemented method of claim 1, wherein building a language model associated with each particular unique identifier comprises:
identifying the textual inputs associated with the particular unique identifier;
determining a probability of occurrence associated with each token in the textual inputs; and
storing each token and its associated probability of occurrence.

3. The computer-implemented method of claim 1, wherein receiving the plurality of textual inputs comprises receiving textual inputs from a plurality of users.

4. The computer-implemented method of claim 1, wherein building a language model associated with each particular unique identifier comprises adapting a general language model based on the textual inputs associated with the particular unique identifier.

5. The computer-implemented method of claim 4, wherein adapting the general language model based on the textual inputs associated with the particular unique identifier comprises increasing probabilities of occurrence of particular tokens in the general language model when the particular tokens are present in the plurality of textual inputs.

6. The computer-implemented method of claim 1, wherein the request for the context specific language model includes an application identifier that identifies an application associated with the context specific language model.

7. The computer-implemented method of claim 6, further comprising transmitting, from the computing device, the application to the user computing device.

8. A computer system, comprising:
one or more processors; and
a non-transitory, computer readable medium storing instructions that, when executed by the one or more processors, cause the computer system to perform operations comprising:
receiving a plurality of textual inputs, each of the textual inputs being received in association with an input field;
receiving a plurality of unique identifiers, each unique identifier being associated one of the plurality of textual inputs and identifying a type of the input field;
building a language model associated with each particular unique identifier, each language model being based on the textual inputs associated with the particular unique identifier;
receiving a request for a context specific language model from a user computing device, the request including a first unique identifier of the plurality of unique identifiers;
identifying the context specific language model based on the request and the first unique identifier; and
transmitting the context specific language model to the user computing device.

9. The computer system of claim 1, wherein building a language model associated with each particular unique identifier comprises:
identifying the textual inputs associated with the particular unique identifier;
determining a probability of occurrence associated with each token in the textual inputs; and
storing each token and its associated probability of occurrence.

10. The computer system of claim 8, wherein receiving the plurality of textual inputs comprises receiving textual inputs from a plurality of users.

11. The computer system of claim 8, wherein building a language model associated with each particular unique identifier comprises adapting a general language model based on the textual inputs associated with the particular unique identifier.

12. The computer system of claim 11, wherein adapting the general language model based on the textual inputs associated with the particular unique identifier comprises increasing probabilities of occurrence of particular tokens in the general language model when the particular tokens are present in the plurality of textual inputs.

13. The computer system of claim 8, wherein the request for the context specific language model includes an application identifier that identifies an application associated with the context specific language model.

14. The computer system of claim 13, wherein the operations further comprise transmitting the application to the user computing device.

15. A computer-implemented method, comprising:
receiving, at a computing device having one or more processors, a plurality of textual inputs, each of the textual inputs being received in association with an input field;
receiving, at the computing device, a plurality of unique identifiers, each unique identifier being associated one of the plurality of textual inputs and identifying a type of the input field;
building, at the computing device, a language model associated with each particular unique identifier, each language model being based on the textual inputs associated with the particular unique identifier; and
storing, at the computing device, the language models such that each particular language model can be retrieved based on its associated particular unique identifier.

16. The computer-implemented method of claim 15, wherein receiving the plurality of textual inputs comprises receiving textual inputs from a plurality of users.

17. The computer-implemented method of claim 15, wherein building a language model associated with each particular unique identifier comprises adapting a general language model based on the textual inputs associated with the particular unique identifier.

18. The computer-implemented method of claim 17, wherein adapting the general language model based on the textual inputs associated with the particular unique identifier comprises increasing probabilities of occurrence of particular tokens in the general language model when the particular tokens are present in the plurality of textual inputs.

19. The computer-implemented method of claim 15, further comprising:
receiving, at the computing device, a first unique identifier of the plurality of unique identifiers from a user computing device;
identifying, at the computing device, a context specific language model based on the first unique identifier; and
providing, to the user computing device, access to the context specific language model.

20. The computer-implemented method of claim 19, wherein providing access to the context specific language model comprises:
receiving, at the computing device, text from the user computing device;
identifying, at the computing device, at least one text candidate based on the identified context specific language model and the text from the user computing device; and
transmitting, from the computing device, the at least one text candidate to the user computing device.
